(19) United States
(12) Patent Application Publication
(10) Pub. No.: US 2004/0125975 A1
(43) Pub. Date: Jul. 1, 2004

(54) Microphone unit and mehod for adjusting acoustic resistance of acoustic resistor

(75) Inventors: Shingo Suzuki, Sagamihara-shi (JP); Noriko Matsui, Tokyo (JP); Hiroshi Akino, Sagamihara-shi (JP)

Correspondence Address: WELSH & KATZ, LTD, 120 S RIVERSIDE PLAZA, 22ND FLOOR, CHICAGO, IL, 60606, US

(73) Assignee: Kabushiki Kaisha Audio-Technica, Tokyo (JP)

(21) Appl. No.: 10/734,962

(22) Filed: Dec. 12, 2003

(30) Foreign Application Priority Data
Dec. 18, 2002 (JP) 2002-366068

(51) Int. Cl. H04R 9/08; H04R 11/04; H04R 17/02

(52) U.S. Cl. 381/369

(57) ABSTRACT

The present invention relates to a microphone unit including an acoustic resistor having homogeneous acoustic resistance by excluding non-uniformity of the material of an acoustic resistor used in a microphone unit and by excluding non-uniformity of adjusting-operations which are operated by individuals of operators. The invention also relates to a method for adjusting the acoustic resistance of the acoustic resistor used in the microphone unit.

When the acoustic resistance of the acoustic resistor used in the microphone unit is adjusted, a sheet of thermo-plastic material having continuous air bubbles is used as the acoustic resistor, and a predetermined airflow (acoustic resistance) can be obtained by crushing the air bubbles in one portion of the sheet of thermoplastic material with a heating means such as a light energy emitting source.

### FIELD OF THE INVENTION

The present invention relates to a microphone unit and a method for adjusting acoustic resistance of an acoustic resistor used in the microphone unit.

### BACKGROUND OF THE INVENTION

According to a sectional view of FIG. 3 and an exploded perspective view of FIG. 4, the structure of a typical microphone unit of prior arts will be described. the microphone unit 1, which is unidirectional, includes a vibrating plate (a diaphragm) 10 vibrating by sound waves and a charge back-plate 12, which is formed from material such as electret material, so disposed as to face to the vibrating plate, through the a spacer ring 11. The microphone unit also includes a cylinder (an insulating washer) 20 supporting the charge back-plate 12.

The cylinder 20 includes a cylindrical body having a bottom and supports the charge back-plate 12 in the opening face of one end of the cylinder. Rear acoustic terminal holes 21 are formed for obtaining a unidirectional characteristic of the microphone unit, on the bottom of the cylinder 20. A guiding cylinder 22 is disposed and protruded for penetrating a contact pin 23 in the center of the bottom of the cylinder 20. An external thread is formed for screwing together with a nut 25 which is described below, on the external surface of the guiding cylinder 22.

As shown in FIG. 4, generally, a plurality of the rear acoustic terminal holes 21 are so arranged as to form a concentric circle around the guiding cylinder 22. A contact pin 23 is a rely pin for connecting the charge back-plate 12 to an impedance converter which is not shown. Actually, one end of the contact pin is fixed to the charge back-plate 12, in which, however, it is not shown.

An acoustic resistor (damper) 24 is so disposed as to cover the rear acoustic terminal holes 21 on the external surface of the bottom of the cylinder 20. The acoustic resistor 24, which is formed to be ring-shaped, has a hole which is fit with the guiding cylinder 22. The resistor 24 is fixed to the external surface of the bottom of the cylinder 20 by the nut 25 screwing together with the guiding cylinder 22.

Generally, material such as felt, sponge, mesh or cloth, which has air permeability, is used as material of the acoustic resistor 24. The directional characteristic of a microphone unit is determined by an acoustic resistance of an acoustic resistor. The acoustic resistance is the resistance to sound waves in the sound waves passing path. That is, the resistance is quantity of airflow.

In prior arts, there are two methods for adjusting an acoustic resistance by restricting the sound waves passing path. The first method is that the sound waves passing path is restricted by an adhesive or the like applied to the surface of an acoustic resistor. The second method is that the sound waves passing path is restricted by the nut 25 compressing the acoustic resistor 24. In the viewpoint of simplicity, the second method is generally employed.

Microphones have various applications. Especially, a microphone used in a conference room or used as a sound pickup microphone in a studio is required to have an accurate directional characteristic. Effects on which a directional characteristic of a microphone is affected by an acoustic resistance of the acoustic resistor 24 will be described hereinafter.

In a unidirectional microphone, sound waves supplied from the rear acoustic terminal holes 21 is divided by the acoustic resistor 24 including the rear acoustic terminal holes 21 and the acoustic capacity of the rear (the side of the charge back-plate 12) of the vibrating plate 10. Then, the divided sound waves are given-to the rear of the vibrating plate 10.

In case of a first-order sound pressure gradient unidirectional microphone, provided that a is the ratio of an omnidirectional component and a bidirectional component,

α=(r1×c)/(s1×d)

where r1 is acoustic resistance value, s1 is acoustic capacity value, d is the distance between the front acoustic terminal and the rear acoustic terminal and c is the speed of sound.

In order to obtain a cardioid characteristic as α=1, the ratio of an omnidirectional component and a bidirectional component needs to be one to one. Incidentally, provided that α=0.5, the directional characteristic becomes hyper-cardioid.

According to the above formula, c is the constant and s1 (acoustic capacity) is determined by mechanical dimensions, and then, s1 can be set as planed. Therefore, the required directional characteristic can be obtained by adjusting the r1 of the remained parameter (an acoustic resistance value).

However, it is difficult that the acoustic resistance is accurately adjusted as planed by fastening the nut 25 as above-described. Several reasons will be described as follows. The first, the material of the acoustic resistor 24 is not uniform. The second, since different operators have different ways of fastening the nut, the dispersion by differences among individuals of operators occurs. The third, the adjusted acoustic resistance value varies by a good or a poor engagements between the nut 24 and the thread of the screw of the guiding cylinder 22. The fourth, when the acoustic resistance is adjusted by the nut fastened with a tool, the resistance which is measured while the tool is touched to the nut happens to be deferent from the resistance which is measured after the tool has been detached from the nut. The fifth, the acoustic resistor is aged in order that the resistance is not varied by the change of environments (temperature, humidity). After the aging, the acoustic resistor happens to be varied by the loosened nut.

### SUMMARY OF THE INVENTION

The present invention is directed to solve the problems described above. it is, therefore, an object of the present invention to provide a microphone unit including an acoustic resistor of which an acoustic resistance is adjusted by a non-contact way and is not varied across the ages. It is another object of the invention to provide a method for adjusting the acoustic resistance of the acoustic resistor.

In order to carry out the objects above-described, the first aspect of this invention will be described bellow. A microphone unit includes a vibrating plate, a charge back-plate so disposed as to face to the vibrating plate, through a spacer and a cylinder supporting the charge back-plate in the opening of one end of the cylinder and having rear acoustic terminal holes on the bottom of the other end of the cylinder. An acoustic resistor is so disposed as to cover the rear acoustic terminal holes on the external surface of the bottom of the cylinder. It is characterized in that the acoustic resistor is formed from a sheet of thermo-plastic porous material having continuous air bubbles, which of one portion of the sheet are crushed by being heated.

One of various thermo-plastic synthetic resin, as well as spongy rubber material are included in the kind of thermo-plastic porous material, which is used as the acoustic resistor, having continuous air bubbles. However, porous polyurethane is preferably used, since the portion of the depth from the surface to a few micrometers of the porous polyurethane is easily melt by a light emitter of a xenon lamp, a halogen lamp or the like and the air bubbles in the portion are crushed and the portion of the porous polyurethane is clogged.

The second aspect of this invention will be described bellow. This aspect related to a method for adjusting the acoustic resistance of the acoustic resistor. It is characterized in that a sheet of the thermo-plastic porous material, which has continuous air bubbles, is used as the acoustic resistor, and the air bubbles in one portion of the sheet of the thermo-plastic porous material are crushed by a heater, and then, a predetermined quantity of airflow (acoustic resistance) is obtained.

In case of the second aspect, it is included in this invention that the sheet of thermo-plastic porous material is heated and compressed to a predetermined thickness of the sheet and then, the heated and compressed thermo-plastic porous sheet is heated by the heater. That is, after quantity of airflow has been course-adjusted by the heat and compression, the quantity of airflow is fine-adjusted by the heater.

A contacting heating means such as a heater-iron is used as the heater, however, a light energy emitting source such as a xenon lamp, a halogen lamp or a laser lighting source, which can non-contact-heat, is preferably used.

### BRIEF DESCRIPTION OF THE DRAWINGS

FIG. 1 is a schematic sectional view of a microphone unit of this invention.

FIG. 2 is an exploded perspective view of a microphone unit of this invention.

FIG. 3 is a schematic sectional view of a microphone unit of prior arts.

FIG. 4 is an exploded perspective view of a microphone unit of prior arts

### DETAILED DESCRIPTION OF THE PREFERRED EMBODIMENTS

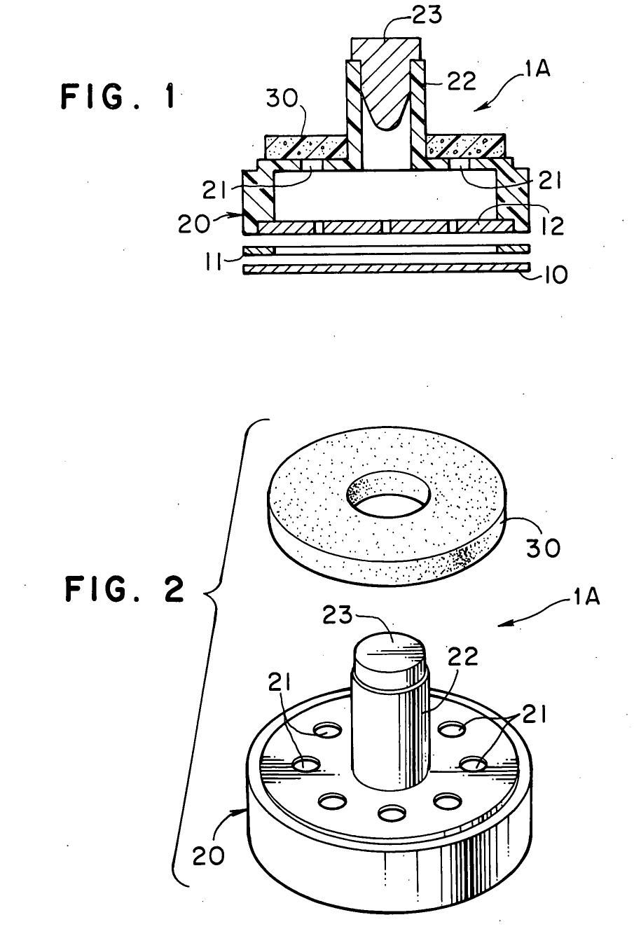

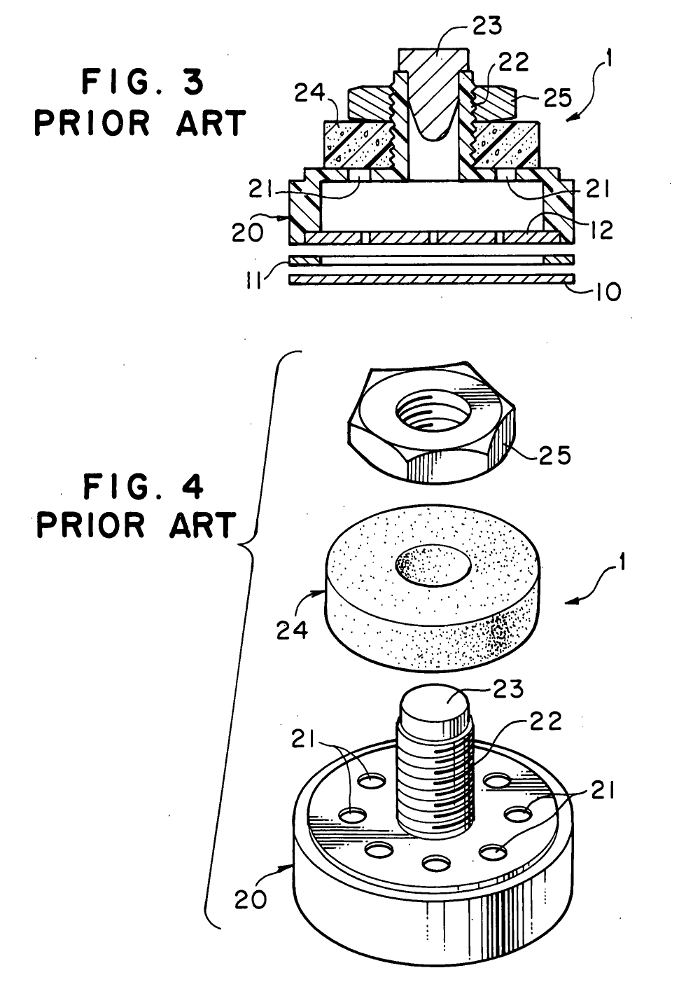

Referring to FIGS. 1 and 2, an embodiment will be described. FIG. 1 is a schematic sectional view of a microphone of the present invention, which corresponds to FIG. 3 of prior arts. FIG. 2 is an exploded perspective view of the microphone, which corresponds to FIG. 4 of prior arts. In the description of the embodiment of this invention, members which are identified or are deemed to be identified with members of prior arts described above are attached with the same reference numerals as ones of prior arts.

The microphone unit 1A is also a unidirectional capacitor microphone unit like a microphone unit of prior arts described above. The microphone unit 1A includes a vibrating plate 10 vibrated by sound waves, a charge back-plate 12 so disposed as to face the vibrating plate 10 through a spacer ring 11 and a cylinder (an insulating washer) 20 supporting the charge back-plate 12.

The cylinder 20 includes a cylindrical body having a bottom and supports the charge back-plate 12 in the opening face of one end of the cylinder. Rear acoustic terminal holes 21 are formed on the bottom of the cylinder 20 for obtaining a unidirectional characteristic of the microphone unit. A guiding cylinder 22 is disposed and protruded for penetrating a contact pin 23 in the center of the bottom of the cylinder 20. In this example, no external thread is formed in the guiding cylinder 22.

A plurality of the rear acoustic terminal holes 21 are so arranged as to form a concentric circle around the guiding cylinder 22. The contact pin 23 is a rely pin for connecting the charge back-plate 12 to an impedance converter which is not shown. One end of the contact pin is actually fixed to the charge back-plate 12, however, in which it is not shown.

An acoustic resistor (a damper) 30 is so disposed as to cover the rear acoustic terminal holes 21, on the external surface of the bottom of the cylinder 20. The acoustic resistor 30, which is formed ring-shaped, has a hole fit with the guiding cylinder 22.

In this invention, the acoustic resistor 30 is formed from a sheet of thermo-plastic porous material having continuous air bubbles. The air bubbles of one portion of the sheet of thermo-plastic porous material are crushed by being heated and the portion of the sheet is clogged. Then acoustic resistance (quantity of airflow) of the resistor 30 can be adjusted.

One of various kinds of thermo-plastic synthetic resin, as well as spongy rubber material or the like can be used as the thermoplastic porous material of the acoustic resistor 30, in which porous polyurethane is preferably used.

Porous polyurethane is formed from thermoplastic polyurethane mixed with particles of calcium carbonate, each of which has a diameter of, for example, 20 to 50 μm, and the mixed thermo-plastic polyurethane is kneaded and extrusion-molded. Finally, calcium carbonate is eluted from the molded porous polyurethane by a solvent. Porous polyurethane is porous material which includes continuous air bubbles having percentage of voids of 80% by volume. The portion of the depth from the surface to a few micrometers of the porous polyurethane easily melts by emitting light by a xenon lamp, a halogen lamp or the like. Then, air bubbles in the portion of the porous polyurethane are crushed and the portion of the porous polyurethane is clogged.

One of light energy emitters, such as a xenon lamp, a halogen lamp or a laser lighting source is preferably used for adjusting the acoustic resistor by non- contact heating as the heater for the acoustic resistor 30. However, in this invention, a contact heater such as a heater-iron is not excluded.

One or both surfaces of the acoustic resistor 30 are heated. It depends on the quantity of adjustment of the acoustic resistance that one face is heated or both faces are heated. However, as another aspect, when the large quantity of adjustment of the acoustic resistance is required, the acoustic resistor 30 is heated and compressed into predetermined thickness as a coarse adjustment and then, the resistor is heated for a fine adjustment. Such aspect is included in this invention.

In a manufacturing process of the acoustic resistor, it is preferable that a mother sheet of the acoustic resistor is heated, and the acoustic resistor is cut out of the heated mother sheet.

In FIGS. 1 and 2, a fixing member for fixing the acoustic resistor 30 to the cylinder 20 is not shown. A nut can be used for fixing the resistor to the cylinder as above-described prior arts or an adhesive can be also used. When the nut is used, the acoustic resistor should be lightly pressed by the nut and the resistor should not tightly fastened. On the other hand, when an adhesive is used, it is preferable that the adhesive is applied to the portion of the resistor except the rear acoustic terminal holes 21.

A concrete example of the method for adjusting the acoustic resistance of the acoustic resistor will be described below. Scott Filter HR 50 of the brand name to Bridgestone Corporation, of which material is porous polyurethane, is used as the sample of the acoustic resistor. A sheet of the Scott Filter HR 50 is heated and compressed into 1 mm, the thickness of which is that of ⅕ compared with the former thickness. The sample of the acoustic resistor is cut out from the heated and compressed sheet and is formed like a ring having a bore diameter of 2.5 mm and an outer diameter of 5.5 mm.

A compressed air is applied to one face of the sample. The deference of the pressure between the compressed air of the one surface of the sample and the air pressure on the other surface is measured as the acoustic resistance. A laser emitter, the wave length of which is 785 nanometers and the power strength of which is 60 milliwatts, is used for heating the sample. The deference of the pressure is measured at four times, that is, before the laser emitting, after the first laser emitting, after the second laser emitting and after the third laser emitting. Each of the laser emitting continues for 30 second. The one surface of the whole area of the sample is emitted by the laser emitter. The deference of the pressure at each time is as follows.

(Where the unit of mmH₂O is water head.)

| | |
|---|---|
| Before the laser emitting | 298 mmH₂O |
| After the first laser emitting | 284 mmH₂O (the deference |
| | compared with the value |
| | before the laser emitting |
| | is 14 mmH₂O) |
| After the second laser emitting | 281 mmH₂O (the deference |
| | compared with the value |
| | of the first laser emitting |
| | is 3 mmH₂O) |
| After the third laser emitting | 277 mmH₂O (the deference |
| | compared with the value |
| | of the second laser emitting |
| | is 4 mmH₂O) |

As the results, it is proven that the longer is the laser emitting time (heating time), the larger is the acoustic resistance.

As described above, the acoustic resistor, the acoustic resistance of which is uniform, can be obtained by emitting a laser while the acoustic resistance is measured. Dispersion by the material of the acoustic resistor or by adjusting work of each of operators is excluded and then the acoustic resistors having uniform resistance are mass-produced.

As above-described, according to the first aspect of this invention, the microphone unit includes the vibrating plate, the charge back-plate so disposed as to face to the vibrating plate, through the spacer and the cylinder supporting the charge back-plate in the opening face of one end of the cylinder and having rear acoustic terminal holes on the bottom of the other end of the cylinder. The acoustic resistor is so disposed as to cover the rear acoustic terminal holes on the external surface of the bottom of the cylinder. The acoustic resistor is formed from a sheet of thermo-plastic porous material having continuous air bubbles, which of one portion of the sheet of thermo-plastic porous material are crushed by being heated. Then, the microphone unit is provided with the acoustic resistor having the acoustic resistance which is not varied across the ages.

According to the second aspect of this invention, the air bubbles of the one portion of the sheet of the thermo-plastic porous material which is used as the acoustic resistor are crushed by a heater to obtain the predetermined quantity of airflow (acoustic resistance), and then, the dispersion by the materials of the acoustic resistor or by adjusting work of each of operators is excluded and the acoustic resistors having uniform resistance are mass-produced.

1. A microphone unit including a vibrating plate and a charge back-plate so disposed as to face to the vibrating plate, through a spacer, said microphone unit including a cylinder supporting the charge back-plate in the opening face of one end of the cylinder and having a rear terminal hole on the bottom of the other end of the cylinder, said microphone unit including an acoustic resistor so disposed as to cover the acoustic terminal hole, said microphone unit comprising:
a sheet of thermo-plastic porous material forming the acoustic resistor, said sheet of thermo-plastic porous material having continuous air bobbles; and
wherein the air bubbles of the sheet of thermo-plastic porous material are crushed by being heated.

2. A microphone unit according to claim 1, wherein the sheet of thermoplastic porous material is a sheet of porous polyurethane.

3. A microphone unit according to claim 1, wherein the sheet of thermo-plastic porous material is heated with the sheet of thermo-plastic porous material being a mother sheet of the thermo-plastic porous material, and then the acoustic resistor is cut out from the heated mother sheet of the thermo-plastic porous material.

4. A method for adjusting an acoustic resistance of an acoustic resistor used in a microphone unit, comprising the steps of:
using a sheet of thermo-plastic porous material having continuous air bobbles as the acoustic resistor; and
obtaining a predetermined quantity of airflow by crushing the air bubbles in one portion of the sheet of thermo-plastic porous material, by a heater.

5. A method for adjusting an acoustic resistance of an acoustic resistor according to claim 4, the method comprising the steps of:
heating and compressing the sheet of thermoplastic porous material to a predetermined thickness; and
heating the heated and compressed sheet of thermoplastic porous material by the heater.

6. A method for adjusting an acoustic resistance of an acoustic resistor according to claim 4, the method comprising the step of using a light energy emitting source as the heater.

7. A method for adjusting an acoustic resistance of an acoustic resistor according to claim 5, the method comprising the step of using a light energy emitting source as the heater.

8. A method for adjusting an acoustic resistance of an acoustic resistor according to claim 4, the method comprising the steps of measuring the acoustic resistance while heating the sheet of thermoplastic porous material, and adjusting a predetermined acoustic resistance value.

9. A method for adjusting an acoustic resistance of an acoustic resistor according to claim 5, the method comprising the steps of measuring the acoustic resistance while heating the sheet of thermoplastic porous material, and adjusting a predetermined acoustic resistance value.
